(19) United States
(12) Patent Application Publication
(10) Pub. No.: US 2025/0081155 A1
(43) Pub. Date: Mar. 6, 2025

(54) Systems and Methods for Receiving Incoming Messages Via Satellite

(71) Applicant: Google LLC, Mountain View, CA (US)

(72) Inventors: Amol Tuli, Dublin, CA (US); Pavan Santhana Krishna Nuggehalli, San Carlos, CA (US); Sooraj Sasindran, San Diego, CA (US); Jean-Francois Vincent-Girard, Cupertino, CA (US); Saravanaraj Duraisamy, San Francisco, CA (US)

(21) Appl. No.: 18/811,664

(22) Filed: Aug. 21, 2024

Related U.S. Application Data
(60) Provisional application No. 63/536,043, filed on Aug. 31, 2023.

(51) Int. Cl. H04W 64/00; H04W 76/10; H04W 84/06

(52) U.S. Cl. CPC H04W 64/003; H04W 76/10; H04W 84/06

(57) ABSTRACT

A computer-implemented method is provided. The method includes determining, by a user device, that the user device is within range of a particular satellite. The method also includes sending, by the user device, a connection request to the particular satellite in response to determining that the user device is within range of the particular satellite. The connection request is forwarded to a network device, via the particular satellite, to indicate to the network device that the user device is available to receive messages via the particular satellite. The method also includes receiving, by the user device and via the particular satellite, a message from the network device in response to sending the connection request.

### CROSS-REFERENCE TO RELATED APPLICATIONS

The present application claims the benefit of U.S. Provisional Patent Application No. 63/536,043, filed Aug. 31, 2023. The contents of which are hereby incorporated by reference in their entirety.

### BACKGROUND

A user device can utilize satellite messaging to communicate with other devices when the user device does not have cellular coverage (or has limited cellular coverage). However, because some satellites are constantly changing positions relative to the Earth due to their orbits (e.g., Low Earth Orbit), the user device may frequently lose satellite connectivity. As a non-limiting example, the user device can have satellite connectivity for a short period of time, but as a satellite moves away from the user device, the user device may lose connectivity for extended periods of time. During this time of lost connectivity, the user device may not be able to receive messages via satellite messaging.

Moreover, if the user device briefly regains connectivity to either the same satellite or a different satellite, in some scenarios, the user device may not receive pending/incoming messages from a base station. For example, the base station may not know when the user device has briefly regained satellite connectivity and thus may attempt to relay satellite messages to the user device at times when the user device does not have satellite connectivity. As a result, it may be relatively difficult for the user device to receive messages via satellite messaging. If the user device is engaged in sending emergency messages via satellite messaging, this difficulty can make it hard for the user to receive messages and/or responses from third parties (e.g., emergency services) via satellite messaging.

### SUMMARY

To ensure that a user device promptly receives a pending message via satellite messaging, the user device can proactively switch from an idle state (e.g., a Radio Resource Control (RRC) idle state) to a connected state (e.g., an RRC connected state) upon a user device determination that the user device is within range of a satellite. For example, the user device can scan different frequency bands to detect the presence of the satellite. In response to detecting the presence of the satellite, the user device can send a connection request to a network device via the satellite. Based on the connection request, the user device can establish a connection with the network device such that the user device switches to a connected state, and the network device can send pending/incoming messages to the user device via the satellite once the connection is established.

In one aspect, a computer-implemented method is provided. The method includes determining, by a user device, that the user device is within range of a particular satellite. The method also includes sending, by the user device, a connection request to the particular satellite in response to determining that the user device is within range of the particular satellite. The connection request is forwarded to a network device, via the particular satellite, to indicate to the network device that the user device is available to receive messages via the particular satellite. The method also includes receiving, by the user device and via the particular satellite, a message from the network device in response to sending the connection request.

In another aspect, a user device is provided. The user device includes a memory and a processor coupled to the memory. The processor is configured to determine that the user device is within range of a particular satellite. The processor is also configured to send a connection request to the particular satellite in response to determining that the user device is within range of the particular satellite. The connection request is forwarded to a network device, via the particular satellite, to indicate to the network device that the user device is available to receive messages via the particular satellite. The processor is also configured to receive, via the particular satellite, a message from the network device in response to sending the connection request.

In another aspect, a non-transitory computer-readable medium is provided. The non-transitory computer-readable medium includes instructions that are executable by a processor within a user device to perform operations. The operations include determining that the user device is within range of a particular satellite. The operations also include sending a connection request to the particular satellite in response to determining that the user device is within range of the particular satellite. The connection request is forwarded to a network device, via the particular satellite, to indicate to the network device that the user device is available to receive messages via the particular satellite. The operations also include receiving, via the particular satellite, a message from the network device in response to sending the connection request.

In another aspect, a computer-implemented method is provided. The method includes forwarding, by a network device, an initial message received from a user device to a recipient. The initial message is received via a satellite. The method also includes determining, by the network device, whether a response to the initial message is urgent based on a context of the initial message or based on the recipient. The method also includes determining, by the network device and based on a location of the user device, a likelihood that the user device is within range of at least one satellite. The method also includes sending, by the network device and via the at least one satellite, a connection request to the user device in response to a determination that the response to the initial message is urgent and a determination that the user device is likely within range of the at least one satellite. The method also includes forwarding, by the network device and to the user device, a response message from the recipient in response to establishing a connection with the user device via the connection request.

In another aspect, a network device is provided. The network device includes a memory and a processor coupled to the memory. The processor is configured to forward an initial message received from a user device to a recipient. The initial message is received via a satellite. The processor is also configured to determine whether a response to the initial message is urgent based on a context of the initial message or based on the recipient. The processor is also configured to determine, based on a location of the user device, a likelihood that the user device is within range of at least one satellite. The processor is also configured to send, via the at least one satellite, a connection request to the user device in response to a determination that the response to the initial message is urgent and a determination that the user device is likely within range of the at least one satellite. The processor is also configured to forward, to the user device, a response message from the recipient in response to establishing a connection with the user device via the connection request.

In another aspect, a non-transitory computer-readable medium is provided. The non-transitory computer-readable medium includes instructions that are executable by a processor within a network device to perform operations. The operations include forwarding an initial message received from a user device to a recipient. The initial message is received via a satellite. The operations also include determining whether a response to the initial message is urgent based on a context of the initial message or based on the recipient. The operations also include determining, based on a location of the user device, a likelihood that the user device is within range of at least one satellite. The operations also include sending, via the at least one satellite, a connection request to the user device in response to a determination that the response to the initial message is urgent and a determination that the user device is likely within range of the at least one satellite. The operations also include forwarding, to the user device, a response message from the recipient in response to establishing a connection with the user device via the connection request.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates a first instance of a system that facilitates reception of incoming messages via satellite;

FIG. 2 illustrates a second instance of the system that facilitates the reception of incoming messages via satellite;

FIG. 3 illustrates a third instance of the system that facilitates the reception of incoming messages via satellite;

FIG. 4 illustrates a block diagram of a user device, in accordance with example embodiments.

FIG. 5 illustrates a block diagram of a network device, in accordance with example embodiments.

FIG. 6 is a flowchart of a method, in accordance with example embodiments.

FIG. 7 is a flowchart of another method, in accordance with example embodiments.

### DETAILED DESCRIPTION

### Overview

The techniques described herein enables a user device to immediately connect to a core network (e.g., a network device) to receive satellite messages when the user device is within range of a satellite. For example, the user device can send a message to a destination device via satellite messaging when the user device is within range of a satellite. In particular, the user device can send the message to the satellite, and the satellite can forward the message to a satellite gateway, the satellite gateway can forward the message to a network device, and the network device can forward the message to the destination device. In some scenarios, the message can be an emergency message (e.g., a message that requires an urgent response). As a non-limiting example, the message can be a text, audio, or video message requesting help, and the destination device can be associated with an emergency service provider. In these scenarios, it may be critical for the user device to receive a prompt response to the message.

However if the user device is in an area without cellular coverage and has to rely on satellite messaging to receive the response, the user device may not receive a prompt response to the message. For example, because some satellites are constantly changing positions relative to the Earth due to their orbits (e.g., Low Earth Orbit), the user device may frequently lose satellite connectivity. Moreover, if the user device briefly regains connectivity to either the same satellite or a different satellite, in some scenarios, the user may not receive the messages from a base station. For example, the base station may not know that the user device has briefly regained satellite connectivity and thus may not attempt to relay satellite messages to the user device during the brief time the user device regains connectivity.

To ensure that the user device promptly receives the response, when the positioning of a particular satellite changes such that the user device is briefly within range of the particular satellite, the user device can send a connection request to the network device via the particular satellite. For example, the user device can scan different frequency bands to determine when the user device is within range of the particular satellite. In response to determining that the user device is within range of the particular satellite, the user device can forcefully move from an RRC idle state to an RRC connected state (e.g., forcefully connect to the network device) through a handshake with the network device. In response to connecting to the network device, the network device can forward any pending/incoming messages to the user device via the satellite gateway and the satellite. As a result, the user device can receive a prompt response when the user device is within the range of the particular satellite.

With respect to the embodiments associated with sending and receiving messages via satellite messaging, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

### Example Satellite Systems

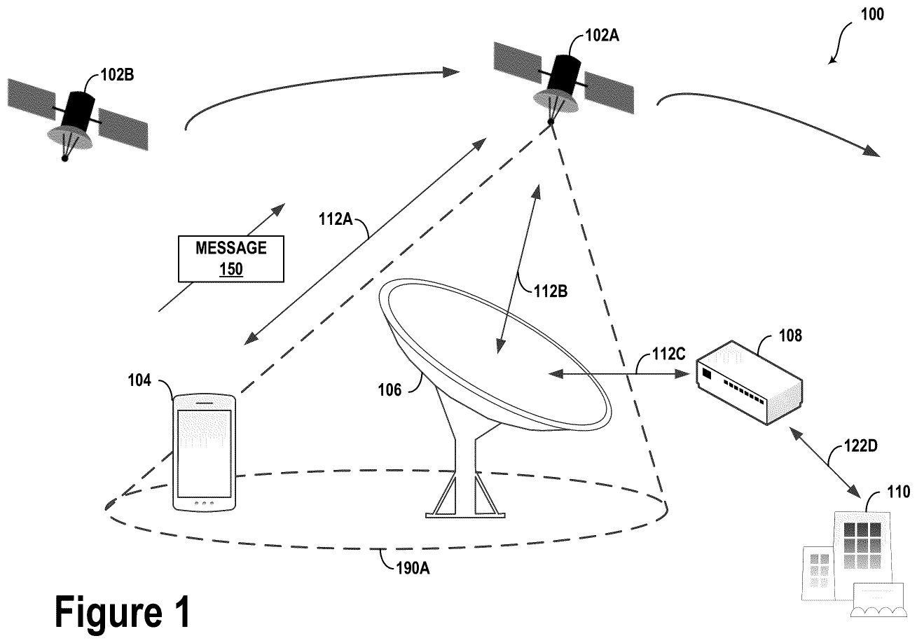

Particular examples are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple satellites are illustrated and associated with reference numbers 102A and 102B. When referring to a particular one of the satellites, such as the satellite 102A, the distinguishing letter “A” is used. However, when referring to any arbitrary one of these satellites or to these satellites as a group, the reference number 102 is used without a distinguishing letter.

FIG. 1 illustrates a first instance 100 of a system that facilitates reception of incoming messages via satellite. The system includes a satellite 102A, a satellite 102B, a user device 104, a satellite gateway 106, a network device 108, and a destination device 110. The user device 104 can correspond to a mobile phone, a laptop computer, a tablet computer, or a wearable computing device, among other possibilities.

The satellites 102A, 102B can correspond to Low Earth Orbit (LEO) satellites that orbit around Earth. As a result, and as depicted in FIG. 1, the satellites 102A, 102B can move around such that the range 190 (e.g., coverage area) of each satellite 102A, 102B is constantly moving. As depicted in FIG. 1, the user device 104 is within a range 190A of the satellite 102A. However, because the satellite 102A is constantly moving, the user device 104 remains in the range 190A of the satellite 102A for a relatively short period of time. As a non-limiting example, the user device 104 can remain in the range 190A of the satellite 102A for approximately ninety (90) seconds. It should be understood that the length of time that the user device 104 is within the range 190A of the satellite 102A can vary. For example, in some scenarios, the user device 104 can remain in the range 190A of the satellite 102A for a longer time period than ninety (90) seconds. In other scenarios, the user device 104 can remain in the range 190A of the satellite 102A for a shorter time period than ninety (90) seconds.

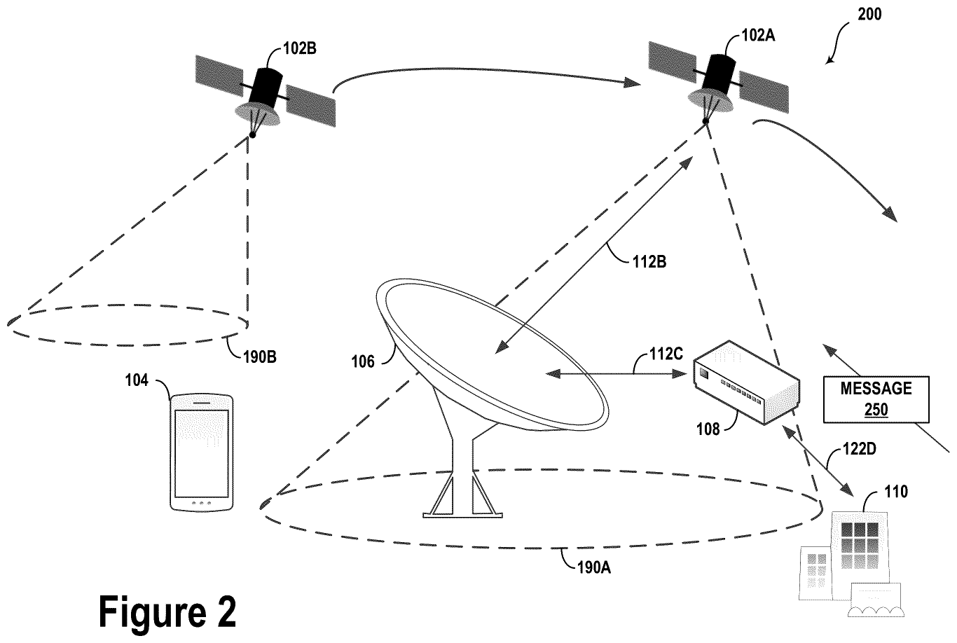

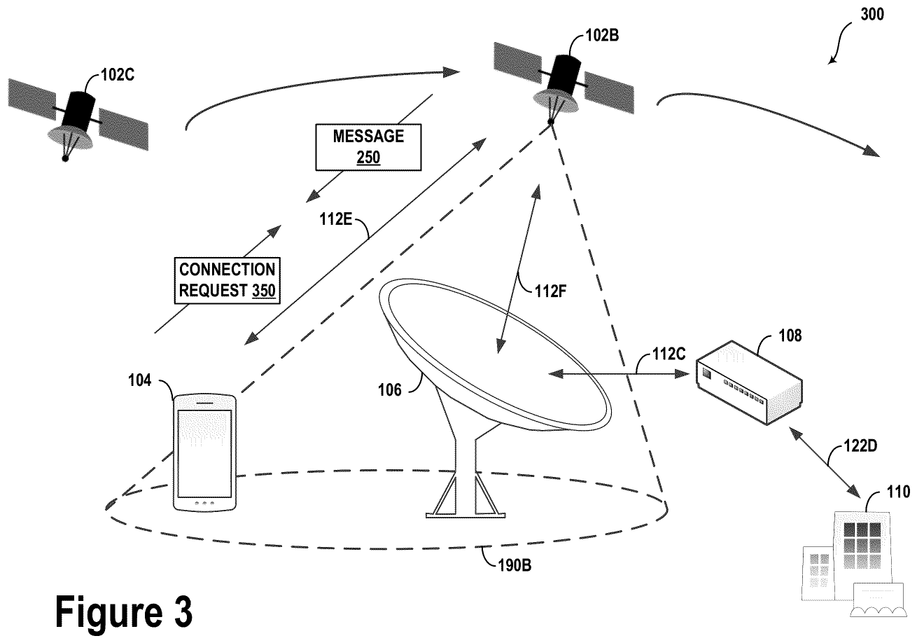

As depicted and described below with respect to FIG. 2, because the satellites 102A, 102B are constantly moving, there are instances when the user device 104 is not within the range 190 of any satellite 102. Typically, the user device 104 is not within the range 190 of any satellite 102 for extended periods of time. As a non-limiting example, there may be scenarios whereby the user device 104 is not within the range 190 of any satellite 102 for ten (10) minutes. As depicted and described with respect to FIG. 3, there are instances when the user device 104 is within the range 190B of another satellite 102B.

Below, techniques are described to facilitate accelerated reception of messages by the user device 104 when the user device 104 enters into the range 190 of a satellite 102. In particular, in response to entering into the range 190 of a satellite 102, the user device 104 can send, via a satellite 102 and the satellite gateway 106, a connection request to the network device 108 to connect with an associated core network and receive pending/incoming messages. In some scenarios, as described below, the connection request can be sent based on a messaging context (e.g., if the pending/incoming messages are related to an emergency).

Referring back to FIG. 1, the user device 104 can communicate with the satellite 102A using a communication link 112A when the user device 104 is within the range 190A of the satellite 102A. The communication link 112A can be a particular frequency or frequency band that enables the user device 104 to send messages to the satellite 102A and receive messages from the satellite 102A. The satellite gateway 106 can communicate with the satellite 102A using a communication link 112B when the satellite gateway 106 is within the range 190A of the satellite 102A. The communication link 112B can be a particular frequency or frequency band that enables the satellite gateway 106 to send messages to the satellite 102A and receive messages from the satellite 102A. The satellite gateway 106 can forward messages from the satellite 102A to the network device 108 using a communication link 112C. The network device 108 can forward messages from devices (e.g., the destination device 110) within a core network associated with the network device 108 to the satellite gateway 106 using the communication link 112C. A communication link 122D can be used to facilitate data communication between the network device 108 and devices (e.g., the destination device 110) within the core network associated with the network device 108.

As illustrated in FIG. 1, the user device 104 can be configured to send an initial message 150 to the satellite 102A when the user device 104 is within the range 190A of the satellite 102A. In some scenarios, a context of the initial message 150 may indicate an urgent situation or an emergency situation. As non-limiting examples, text within the initial message 150 can indicate that a user associated with the user device 104 is stranded, wounded, suffering from a medical emergency, etc. In other scenarios, the context of the initial message 150 may indicate a non-urgent situation. As non-limiting examples, text within the initial message 150 can be indicative of a casual conversation between two acquaintances. It should be understood that although the message 150 is referred to as an “initial” message, the message 150 does not necessarily have to be the first message sent by the user device 104 to a satellite 102. For example, the message 150 can correspond to one of many messages sent to a satellite 102 by the user device 104. As depicted in FIG. 1, the user device 104 uses the communication link 112A to send the initial message 150 to the satellite 102A.

Additionally or in the alternative, in some scenarios, the initial message 150 can include different modes of communication. As a non-limiting example, in some scenarios, the initial message 150 can include a voice message. In these scenarios, the context of the initial message 150 can be determined based on the spoken words in the voice message, the tone of the voice message, etc. For example, if the tone of the voice message sounds excited or full of panic, the context of the initial message 150 may indicate an urgent situation. However, if the tone of the voice message sounds relaxed or calm, the context of the initial message 150 may indicate a non-urgent situation. Alternatively, if certain phrases are uttered in the voice message, such as “help”, “stranded”, “hurt”, “bleeding”, “emergency”, etc., the context of the initial message 150 may indicate an urgent situation. As another non-limiting example, in some scenarios, the initial message 150 can include a video message.

The satellite 102A can be configured to receive the initial message 150 from the user device 104 and forward the initial message 150 to the satellite gateway 106 via the communication link 112B. Upon receiving the initial message 150 from the satellite 102A, the satellite gateway 106 can forward the initial message 150 to the network device 108 using the communication link 112C. The network device 108 can forward the initial message 150 to the destination device 110 using the communication link 112D. In some scenarios, the network device 108 can use Internet Protocol (IP) messaging to send the initial message 150 to the destination device 110.

Thus, in FIG. 1, the user device 104 can utilize satellite messaging to send the initial message 150 to the destination device 110. In particular, the user device 104 can use the satellite communication link 112A to send the initial message 150 to the satellite 102A, and the satellite 102A, the satellite gateway 106, and the network device 108 can route the initial message 150 to the destination device 110. Satellite messaging can be particularly useful when the user device 104 is located in an area where there is no cellular coverage or in an area where there is limited cellular coverage. As a non-limiting example, the user device 104 can be located in a wooded area (e.g., a forest) that has limited (or no) cellular coverage. In these scenarios, the satellites 102 can be the only medium of communication accessible to the user device 104. Thus, in emergency situations, the satellite messaging described with respect to FIG. 1 can be particularly useful in getting an emergency message 150 to an emergency service provider (e.g., the destination device 110).

However, as described in FIG. 2, when the user device 104 is not within the range 190A, 190B of the satellites 102A, 102B, respectively, the user device 104 cannot utilize satellite messaging to receive a response message from the destination device 110.

FIG. 2 illustrates a second instance 200 of the system that facilitates the reception of incoming messages via satellite. The system includes the satellite 102A, the satellite 102B, the user device 104, the satellite gateway 106, the network device 108, and the destination device 110.

As illustrated in FIG. 2, the satellites 102A, 102B have moved and the user device 104 is no longer within the range 190A of the satellite 102A. Additionally, the satellite 102B has not yet reached a position whereby the user device 104 is within the range 190B of the satellite 102B. As a result, in FIG. 2, the user device 104 is not within the range 190 of any satellite 102 and is unable to receive messages from either of the satellites 102A, 102B.

The user device 104 can be configured to determine that the user device 104 is not within the range 190 of at least one satellite 102 after sending the initial message 150 to the satellite 102A. In response to determining that the user device 104 is not within the range 190 of at least one satellite 102, the user device 104 can be configured to transition to an idle state. The idle state can correspond to a low-energy state whereby activity of processing components, such as central processing units (CPUs), transceivers, etc., is reduced to reduce power consumption. However, it should be understood that the user device 104 can periodically scan different frequencies while in the idle state to detect when the user device 104 has come into the range 190 of a satellite 102. For example, the user device 104 can scan different frequencies to detect broadcast messages from a satellite 102. Thus, the user device 104 can determine that the user device 104 is within the range 190 of a satellite 102 when the user device 104 is in the idle state. Once the user device 104 detects a broadcast message from a satellite 102, the user device 104 can attempt to establish a connection with the network device 108 to receive a response to the initial message 150, as described in greater detail with respect to FIG. 3.

Referring to FIG. 2, the destination device 110 can generate a message 250 in response to receiving the initial message 150 generated by the user device 104. For example, the message 250 can be a response message to the initial message 150. The destination device 110 can use the communication link 122D to send the message 250 to the network device 108. The network device 108 can attempt to use the satellite gateway 106 and the satellite 102A to send the message 250 to the user device 104; however, because the user device 104 is no longer within the range 190 of a satellite 102, the user device 104 may not receive the message 250. For example, in FIG. 2, the communication link 112A between the satellite 102A and the user device 104 no longer exists because the user device 104 is out of range 190A of the satellite 102A.

As a result of the user device 104 not being within the range 190 of a satellite 102 and entering into the idle state, the network device 108 can periodically reattempt to send the message 250 to the user device 104. However, because the user device 104 is only within the range 190 of a satellite 102 for a relatively short period of time (e.g., approximately ninety (90) seconds) before entering into another extended period of time out of satellite range 190, it can be increasingly difficult for the network device 108 to send the message 250 to the user device 104 at a time that will enable the user device 104 to receive the message 250.

To reduce the amount of unsuccessful attempts to send the message 250 to the user device 104 via satellite 102, as described with respect to FIG. 3, the user device 104 can alert the network device 108 once the user device 104 is within range 190 of a satellite 102 such that network device 108 can promptly send the message 250 to the user device 104 before the user device 104 enters into an extended period of time out of satellite range 190.

FIG. 3 illustrates a third instance 300 of the system that facilitates the reception of incoming messages via satellite. The system includes the satellite 102B, a satellite 102C, the user device 104, the satellite gateway 106, the network device 108, and the destination device 110. In FIG. 3, the satellite 102A has moved a significant distance from the user device 104, and the satellite 102C has moved closer to the user device 104. The satellite 102B has moved close enough to the user device 104 such that the user device 104 is within the range 190B of the satellite 102B.

In FIG. 3, the user device 104 can be configured to determine that the user device 104 is within the range of the satellite 102B. For example, while in the idle state, the user device 104 can scan different frequencies to detect a broadcast message from the satellite 102B. Once the user device 104 detects a broadcast message on a particular frequency (e.g., a communication link 112E), the user device 104 can determine that the user device 104 is within the range 190B of the satellite 102B.

In response to determining that the user device 104 is within the range 190B of the satellite 102B, the user device 104 can be configured to send a connection request 350 to the satellite 102B. The connection request 350 can be forwarded to the network device 108, via the satellite 102B, to indicate to the network device 108 that the user device 104 is available to receive pending/incoming messages (e.g., the message 250) via the satellite 102B. For example, in response to receiving the connection request 350 from the user device 104 via the communication link 112E, the satellite 102B can forward the connection request 350 to the satellite gateway 106 via a communication link 112F that is usable to communicate data between the satellite 102B and the satellite gateway 106. The satellite gateway 106 can be configured to forward the connection request 350 to the network device 108 via the communication link 112.

In response to receiving the connection request 350 from the user device 104 via the satellite 102B, the network device 108 can be configured to establish a connection with the user device 104. In some scenarios, the network device 108 may initiate a handshake with the user device 104 to establish a connection with the user device 104. Once the network device 108 is connected with the user device 104 such that the user device 104 enters into a connected state, the network device 108 can be configured to send the message 250 (e.g., the response to the initial message 150) to the user device 104. For example, the network device 108 can send the message 250 to the satellite gateway 106 via the communication link 112C, the satellite gateway 106 can forward the message 250 to the satellite 102B via the communication link 112F, and the satellite 102B can forward the message 250 to the user device 104 via the communication link 112E. Thus, the user device 104 can be configured to receive, via the satellite 102B, the message 250 (e.g., the response to the initial message 150 from the destination device 110) from the network device 108 in response to sending the connection request 350.

In some scenarios, communication components can have resource constraints such that it would be impractical for every user device to send a connection request 350 every time a user device is within the range 190 of a satellite 102. As a non-limiting example, in some scenarios, the satellite 102B may have resource constraints such that the satellite 102B can process (e.g., a particular number of requests). To ensure that the satellite 102B is not overloaded with connection requests 350, in some scenarios, transmission of the connection request 350 can be subject to one or more protocols. For example, if reception of the message 250 is urgent, the user device 104 can send the connection request 350 to the satellite 102 in response to a determination that the user device 104 is within the range 190B of the satellite 102B.

To illustrate, the user device 104 can be configured to determine whether reception of the message 250 is urgent prior to determining that the user device 104 is within the range 190B of the satellite 102B. In some scenarios, the determination as to whether reception of the response message 250 is urgent is based on the context of the initial message 150. As non-limiting examples, if the initial message 150 includes text, video, or audio that indicates that a user associated with the user device 104 is stranded, wounded, suffering from a medical emergency, etc., the user device 104 can determine that reception of the response message 250 is urgent. In some scenarios, the determination as to whether reception of the response message 250 is urgent is based on a recipient of the initial message 150. As a non-limiting example, if the initial message 150 is sent to an emergency service provider, the user device 104 can determine that reception of the response message 250 is urgent.

Thus, to prevent overloading that satellite 102B with connection requests 350, the user device 104 can be configured to send the connection requests 350 to the satellite 102B in response to a determination that reception of the response message 250 is urgent.

The techniques described with respect to FIGS. 1-3 enable the user device 104 to immediately receive incoming messages 250 upon getting satellite connectivity (e.g., upon getting in the range 190B of the satellite 102B). For example, when the satellite 102B comes into an area associated with the user device 104, the user device 104 scans for frequency bands (e.g., the communication link 112E) to identify that the network device 108 (e.g., a public land mobile network (PLMN)) is available and forcefully transitions to a connected state (instead of staying in the idle state). In some scenarios, the transition from the idle state to the connected state is forced based on contextual information regarding the user device 104 being engaged in emergency messaging (e.g., messaging that requires an urgent response). Upon identifying the connected user device 104 and the satellite 102B, a base station (e.g., the satellite gateway 106 and the network device 108) can identify pending/incoming messages 250 for the user device 104 and can send the messages 250 to the user device 104.

In some scenarios, the network device 108 can be configured to efficiently (e.g., immediately) determine when the user device 104 is within the range 190B of the satellite 102B. In these scenarios, the network device 108, as opposed to the user device 104, can initiate the connection and send the message 250 to the user device 104 as soon as the user device 104 is within the range 190B of the satellite 102B.

To illustrate, based on the context of the initial message 150 or the context of the response message 250, the network device 108 can be configured to determine whether the response to the initial message 150 is urgent. As non-limiting examples, if the initial message 150 or the response message 250 includes text, video, or audio that indicates that a user associated with the user device 104 is stranded, wounded, suffering from a medical emergency, etc., the network device 108 can determine that reception of the response message 250 is urgent. Additionally, or in the alternative, the network device 108 can determine whether the response to the initial message 150 is urgent based on the recipient of the initial message 150. As a non-limiting example, if the destination device 100 is associated with an emergency service provider, the network device 108 can determine that the response to the initial message 150 is urgent.

The network device 108 can also be configured to determine a location of the user device 104 based on the initial message 150. For example, the initial message 150 can include location information (e.g., Global Navigation Satellite System (GNSS) coordinates) of the user device 104. Based on the location of the user device 104, the network device 108 can be configured to determine a likelihood that the user device 104 is within the range 190B of the satellite 102B. The network device 108 can be configured to send a connection request to the user device 104 (or facilitate a handshake with the user device 104) in response to a determination that the response to the initial message 150 is urgent and a determination that the user device 104 is likely within the range 190B of the satellite 102B. In response to establishing the connection with the user device 104, the network device 108 can be configured to forward the response message 250 to the user device 104.

### Example User Device

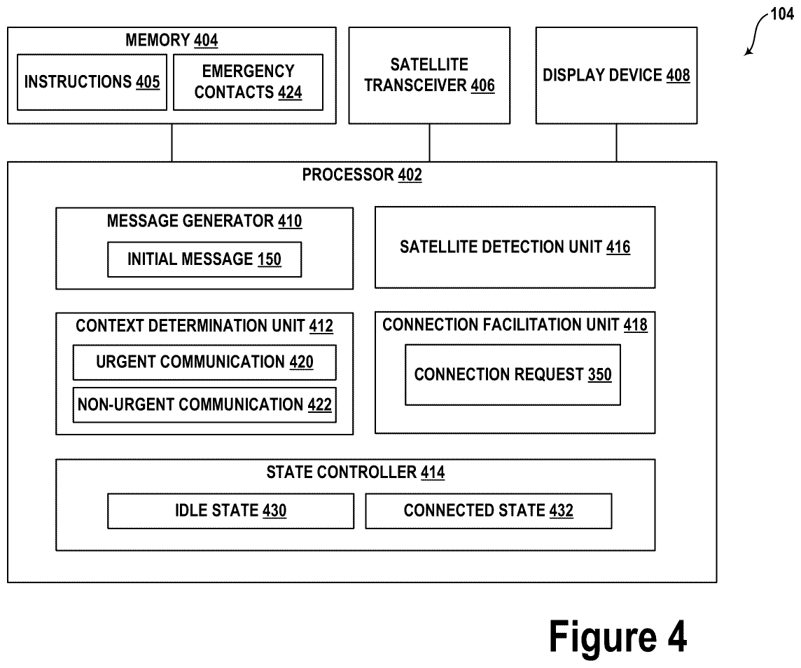

FIG. 4 illustrates a block diagram of the user device 104. The user device 104 includes a processor 402, a memory 404 coupled to the processor 402, a satellite transceiver 406 coupled to the processor 402, and a display device 408 coupled to the processor 402. It should be understood that the components of the user device 104 depicted in FIG. 4 are not intended to be limiting. In other scenarios, the user device 104 can include additional components. As non-limiting examples, the user device 104 can include one or more input devices, a battery, a modulator-demodulator (modem), an encoder, a decoder, etc.

The memory 404 can correspond to a non-transitory computer-readable medium that stores instructions 405 that are executable by the processor 402. For example, the instructions 405 can be executable to cause the processor 402 to perform the operations described herein.

The processor 402 includes a message generator 410, a context determination unit 412, a state controller 414, a satellite detection unit 416, and a connection facilitation unit 418. In one implementation, one or more of the components of the processor 402 can be implemented using dedicated hardware. As non-limiting examples, one or more of the components of the processor 402 can be implemented using an application-specific integrated circuit (ASIC) or a field-programmable gate array (FPGA) device. In one implementation, one or more of the components of the processor 402 can be implemented using software. As a non-limiting example, the functions and/or operations performed by one or more of the components of the processor 402 can be implemented by executing the instructions 405 stored in the memory 404.

The message generator 410 can be configured to generate the initial message 150. After the initial message 150 is generated, the satellite detection unit 416 can scan different frequencies to detect a satellite 102 (e.g., to determine whether the user device 104 is within range 190 of a satellite 102). For example, the satellite detection unit 416 can determine that the user device 104 is within range 190A of the satellite 102A, as depicted in FIG. 1. In response to a determination that the user device 104 is within range 190A of the satellite 102A, the satellite transceiver 406 can send the initial message 150 to the satellite 102A using the communication link 112A.

The context determination unit 412 can be configured to determine a context of the initial message 150. Based on the context of the initial message 150, the context determination unit 412 can classify the initial message 150 as an urgent communication 420 or a non-urgent communication 422. For example, if the context determination unit 412 determines that text within the initial message 150 indicates that a user associated with the user device 104 is stranded, wounded, suffering from a medical emergency, etc., the context determination unit 412 can classify the initial message 150 as an urgent communication 420. However, if the context determination unit 412 determines that text within the initial message is indicative of a casual conversation between two acquaintances, the context determination unit 412 can classify the initial message 150 as a non-urgent communication 422.

As another example, if the context determination unit 412 determines the initial message 150 includes a voice message with (1) an excited/panicked tone or (2) urgent phrases, the context determination unit 412 can classify the initial message 150 as an urgent communication 420. However, if the context determination unit 412 determines the initial message 150 includes a voice message with a relaxed or calm tone, the context determination unit 412 can classify the initial message 150 as a non-urgent communication 422.

The context determination unit 412 can also determine whether the initial message 150 is an urgent communication 420 or non-urgent communication 422 based on an intended recipient of the initial message 150. To illustrate, as depicted in FIG. 4, the memory 404 can store a list of emergency contacts 424. The list of emergency contacts 424 can include contact information for different emergency service providers, next of kin, etc. In some scenarios, the list of emergency contacts 424 can include a predefined set of numbers or other contact information, such as “911” or “411”. In some scenarios, the list of emergency contacts 424 can be editable by a user of the user device 104. If the intended recipient of the initial message 150 is within the list of emergency contacts 424, the context determination unit 412 can classify the initial message as an urgent communication 420.

After the initial message 150 is sent to the satellite 102A, if the satellite detection unit 416 no longer detects a satellite 102 (e.g., if the user device 104 is no longer within range 190 of a satellite 102 as depicted in FIG. 2), the state controller 414 can enter the user device 104 into an idle state 430 (e.g., an RRC idle state). However, when the user device 104 is in the idle state 430, the satellite detection unit 416 can periodically scan different frequencies to detect a satellite (e.g., to determine when the user device 104 is within range 190 of a satellite 102).

When the satellite detection unit 416 determines that the user device 104 is in range 190B of another satellite 102B, the state controller 414 and the connection facilitation unit 418 can work in conjunction with each other to transition the user device 104 into a connected state 432 (e.g., an RRC connected state). For example, the connection facilitation unit 418 can be configured to generate the connection request 350, and the satellite transceiver 406 can be configured to send the connection request 350 to the satellite 102B. As described with respect to FIG. 3, the connection request 350 can be forwarded to the network device 108, via the satellite 102B, to indicate to the network device 108 that the user device 104 is available to receive messages (e.g., the message 250) via the satellite 102B. Thus, after sending out the connection request 350 and connecting with the network device 108 (e.g., transitioning into the connected state 432), the user device 104 can receive the message 250.

In some scenarios, transmission of the connection request 350 can be based on a determination that reception of the message 250 is urgent. For example, if the context determination unit 412 determines that the initial message 150 is an urgent communication 420, the processor 402 can determine that reception of the message 250 is urgent and the connection facilitation unit 418 can send the connection request 350 to the satellite 102B upon a determination that the user device 104 is within the range 190B of the satellite 102B. However, if the context determination unit 412 determines that the initial message 150 is a non-urgent communication 422, the processor 402 can determine that reception of the message 250 is not urgent and the user device 104 can wait for the network device 108 to send the message 250 according to a network device 108 schedule.

The techniques described with respect to FIG. 4 enables the user device 104 to immediately receive incoming messages 250 upon getting satellite connectivity (e.g., upon getting in the range 190B of the satellite 102B). For example, when the satellite 102B comes into an area associated with the user device 104, the satellite detection unit 416 scans for frequency bands (e.g., the communication link 112E) to identify that the network device 108 is available and forcefully transitions to the connected state 432 (instead of staying in the idle state 430). In some scenarios, the transition from the idle state 430 to the connected state 432 is forced based on contextual information regarding the user device 104 being engaged in emergency messaging (e.g., messaging that requires an urgent response). Upon identifying the connected user device 104 and the satellite 102B, a base station (e.g., the satellite gateway 106 and the network device 108) can identify pending/incoming messages 250 for the user device 104 and send the messages 250 to the user device 104.

### Example Network Device

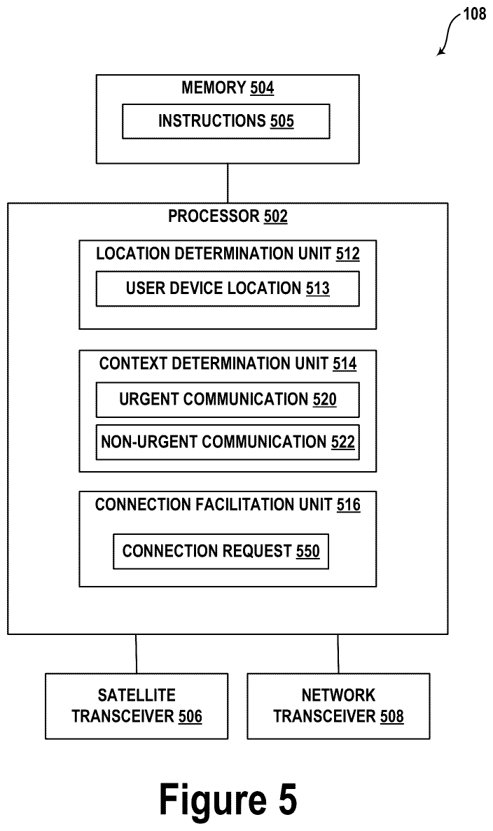

FIG. 5 illustrates a block diagram of the network device 108. The network device 108 includes a processor 502, a memory 504 coupled to the processor 502, a satellite transceiver 506 coupled to the processor 402, and a network transceiver 508 coupled to the processor 502. It should be understood that the components of the network device 108 depicted in FIG. 5 are not intended to be limiting. In other scenarios, the network device 108 can include additional components.

The memory 504 can correspond to a non-transitory computer-readable medium that stores instructions 505 that are executable by the processor 502. For example, the instructions 505 can be executable to cause the processor 502 to perform the operations described herein.

The processor 502 includes a location determination unit 512, a context determination unit 514, and a connection facilitation unit 516. In one implementation, one or more of the components of the processor 502 can be implemented using dedicated hardware. As non-limiting examples, one or more of the components of the processor 502 can be implemented using an ASIC or a FPGA device. In one implementation, one or more of the components of the processor 502 can be implemented using software. As a non-limiting example, the functions and/or operations performed by one or more of the components of the processor 502 can be implemented by executing the instructions 505 stored in the memory 504.

The satellite transceiver 506 can be configured to receive the initial message 150 from the satellite gateway 106, and the network transceiver 508 can be configured to forward the initial message 150 to a recipient (e.g., the destination device 110), as described with respect to FIG. 1. Thus, the satellite transceiver 506 can communicate with the satellite gateway 106, and the network transceiver 508 can communicate with network devices (e.g., devices within a core network of the network device 108).

The location determination unit 512 can be configured to determine a user device location 513 of the user device 104 based on the initial message 150. For example, the initial message 150 can include location information (e.g., GNSS coordinates) of the user device 104.

The context determination unit 514 can operate in a substantially similar manner as the context determination unit 412 of FIG. 4. For example, the context determination unit 514 can be configured to determine whether a response to initial message 150 is urgent based on a context of the initial message 150. To illustrate, if the initial message 150 or the response message 250 includes text, video, or audio that indicates that a user associated with the user device 104 is stranded, wounded, suffering from a medical emergency, etc., the context determination unit 514 can classify the initial message as an urgent communication 520 and determine that reception of the response message 250 is urgent. Additionally, or in the alternative, the network device 108 can determine whether the response to the initial message 150 is urgent based on the recipient of the initial message 150. As a non-limiting example, if the destination device 100 is associated with an emergency service provider, the context determination unit 514 can classify the initial message 150 as an urgent communication 520 and can determine that the response to the initial message 150 is urgent. Otherwise, the context determination unit 514 can classify the initial message 150 as a non-urgent communication 522.

Although the context determination unit 514 is described as analyzing the context of the initial message 150, in some implementations, the context determination unit 412 can use similar techniques to analyze the context of the response message 250 to determine whether the response message 250 is urgent.

Based on the user device location 513, the processor 502 can be configured to determine a likelihood that the user device 104 is within range 190B of the satellite 102B, as depicted in FIG. 3. In response to a determination that the response to the initial message 150 is urgent and a determination that the user device 104 is likely within range 190B of the satellite 102B, the satellite transceiver 506 can be configured to send, via the satellite gateway 106 and the satellite 102B, a connection request 550 to the user device 104. A handshake with the user device 104 can be performed based on the connection request 550, and the satellite transceiver 506 can forward the response message 250 from the recipient (e.g., the destination device 110) to the user device 104 in response to establishing a connection with the user device 104.

Thus, the network device 108 can be configured to efficiently (e.g., immediately) determine when the user device 104 is within the range 190B of the satellite 102B. In these scenarios, the network device 108, as opposed to the user device 104, can initiate the connection and send the message 250 to the user device 104 as soon as the user device 104 is within the range 190B of the satellite 102B.

### Example Methods of Operation

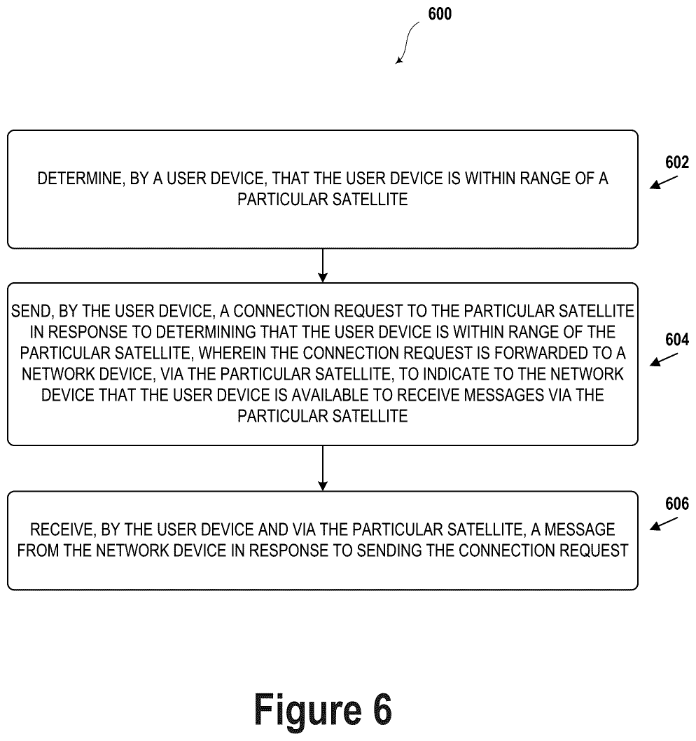

FIG. 6 is a flowchart of a method 600, in accordance with example embodiments. The method 600 can be performed by a user device, such as the user device 104.

The method 600 includes determining, by a user device, that the user device is within a range of a particular satellite, at block 602. For example, referring to FIG. 3, the user device 104 determines that the user device 104 is within the range 190B of the satellite 102B after a period of time when the user device 104 was not within range 190 of a satellite 102.

The method 600 also includes sending, by the user device, a connection request to the particular satellite in response to determining that the user device is within range of the particular satellite, at block 604. The connection request is forwarded to a network device, via the particular satellite, to indicate to the network device that the user device is available to receive messages via the particular satellite. For example, referring to FIG. 3, the user device 104 sends the connection request 350 to the satellite 102B in response to determining that the user device 104 is within range 190B of the satellite 102B. The connection request 350 is forwarded to the network device 108, via the satellite 102B, to indicate to the network device 108 that the user device 104 is available to receive messages 250 via the satellite 102B.

The method 600 also includes receiving, by the user device and via the particular satellite, a message from the network device in response to sending the connection request, at block 606. For example, referring to FIG. 3, the user device 104 receives, via the satellite 102B the message 250 from the network device 108 in response to sending the connection request 350.

According to one implementation, the method 600 includes determining, by the user device, whether reception of the message is urgent prior to determining that the user device is within range of the particular satellite. For example, referring to FIG. 3, the user device 104 determines whether reception of message 250 is urgent prior to determining that the user device 104 is within range 190B of the satellite 102B. The connection request 350 is sent to the particular satellite 102B based on a determination that reception of the message 250 is urgent.

According to one implementation, the method 600 includes sending, by the user device, an initial message to at least one satellite when the user device is within range of the at least one satellite. For example, referring to FIG. 1, the user device 104 sends the initial message 150 to the satellite 102A when the user device 104 is within range 190A of the satellite 102A. The determination as to whether reception of the message 250 is urgent is based on a context of the initial message 150 or based on a recipient of the initial message 150. The message 250 is a response to the initial message 150. According to one implementation of the method 600, the at least one satellite corresponds to a different satellite than the particular satellite. For example, the user device 104 can send the initial message to the satellite 102A and can receive the response message from the satellite 102B. According to one implementation of the method 600, the at least one satellite corresponds to the particular satellite. For example, the user device 104 can send the initial message to the satellite 102A and can receive the response message 250 from the same satellite 102A. In this scenario, the user device 104 may temporarily be outside the range 190A of the satellite 102A when the network device 108 attempts to send the response message 250 to the user device 104. However, when the user device 104 re-enters the range 190A of the satellite 102A, the user device 104 can send the connection request 350 to the network device 108 via the satellite 102A.

According to one implementation, the method 600 can include determining, by the user device, that the user device is not within range of the at least one satellite after sending the initial message to the at least one satellite. For example, referring to FIG. 2, the user device 104 determines that the user device 104 is not within range 190A of the satellite 102A after sending the initial message 150 to the satellite 102A. The method 600 can also include transitioning to an idle state in response to determining that the user device is not within range of the at least one satellite. For example, referring to FIG. 2, the user device 104 transitions to the idle state in response to determining that the user device 104 is not within the range 190 of any satellites 102.

According to one implementation of the method 600, determining that the user device is within range of the particular satellite includes scanning, by the user device, a plurality of frequency bands to detect a presence of the particular satellite. The method 600 can also include transitioning from an idle state to a connected state in response to detecting the presence of the particular satellite. The particular satellite can provide access to a public land mobile network. In some embodiments, the idle state corresponds to a RRC idle state, and the connected state corresponds to a RRC connected state.

The method 600 of FIG. 6 enables the user device 104 to immediately receive incoming messages 250 upon getting satellite connectivity (e.g., upon getting in the range 190B of the satellite 102B). For example, when the satellite 102B comes into an area associated with the user device 104, the user device 104 scans for frequency bands (e.g., the communication link 112E) to identify that the network device 108 is available and forcefully transitions to a connected state (instead of staying in the idle state). In some scenarios, the transition from the idle state to the connected state is forced based on contextual information regarding the user device 104 being engaged in emergency messaging (e.g., messaging that requires an urgent response). Upon identifying the connected user device 104 and the satellite 102B, a base station (e.g., the satellite gateway 106 and the network device 108) can identify pending/incoming messages 250 for the user device 104 and send the messages 250 to the user device 104.

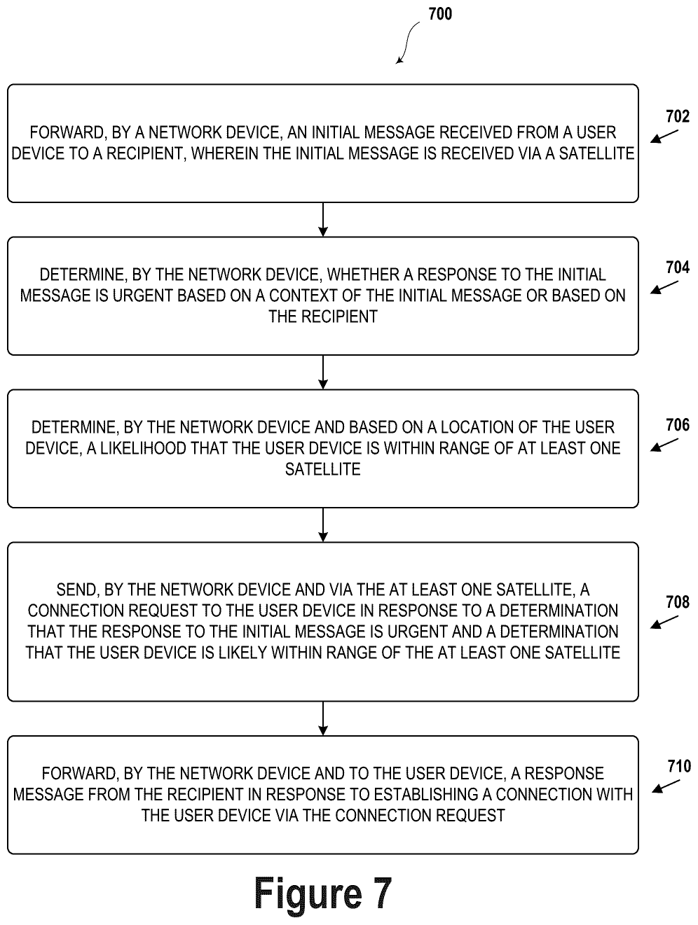

FIG. 7 is a flowchart of another method 700, in accordance with example embodiments. The method 700 can be performed by the network device 108.

The method 700 includes forwarding, by a network device, an initial message received from a user device to a recipient, at block 702. The initial message is received via a satellite. For example, referring to FIG. 1, the network device 108 forwards the initial message 150 received from the user device 104 to the destination device 110. The initial message 150 is received via the satellite 102A and the satellite gateway 106.

The method 700 also includes determining, by the network device, whether a response to the initial message is urgent based on a context of the initial message or based on the recipient, at block 704. For example, referring to FIG. 3, the network device 108 determines whether the response to the initial message 150 is urgent based on the context of the initial message 150 or based on the destination device 110.

The method 700 also includes determining, by the network device and based on a location of the user device, a likelihood that the user device is within range of at least one satellite, at block 706. For example, referring to FIG. 3, the network device 108 determines, based on the location of the user device 104, the likelihood that the user device 104 is within range 190B of the satellite 102B.

The method 700 also includes sending, by the network device and via the at least one satellite, a connection request to the user device in response to a determination that the response to the initial message is urgent and a determination that the user device is likely within range of the at least one satellite, at block 708. For example, referring to FIG. 3, the network device 108 sends, via the satellite gateway 106 and the satellite 102B, the connection request 350 to the user device 104 in response to a determination that the response to the initial message 150 is urgent and a determination that the user device 104 is likely within range 190B of the satellite 102B.

The method 700 also includes forwarding, by the network device and to the user device, a response message from the recipient in response to establishing a connection with the user device via the connection request, at block 710. For example, referring to FIG. 3, the network device 108 forwards, to the user device 104, the response message 250 from the destination device 110 in response to establishing a connection with the user device 104 via the connection request 350.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

With respect to embodiments that include determining a non-common term based on user interaction with a computing device, and/or determining alternative terms using a machine learning model, or interactions by the computing device with cloud-based servers, a user may be provided with controls allowing the user to make an election as to both if and when systems, programs, or features described herein may enable collection of user information (e.g., information about a user's social network, social actions, or activities, profession, a user's preferences, a user's demographic information, a user's current location, or other personal information), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

What is claimed is:

1. A computer-implemented method comprising:
determining, by a user device, that the user device is within range of a particular satellite;
sending, by the user device, a connection request to the particular satellite in response to determining that the user device is within range of the particular satellite, wherein the connection request is forwarded to a network device, via the particular satellite, to indicate to the network device that the user device is available to receive messages via the particular satellite; and
receiving, by the user device and via the particular satellite, a message from the network device in response to sending the connection request.

2. The computer-implemented method of claim 1, further comprising:
determining, by the user device, whether reception of the message is urgent prior to determining that user device is within range of the particular satellite,
wherein the connection request is sent to the particular satellite based on a determination that reception of the message is urgent.

3. The computer-implemented method of claim 2, further comprising:
sending, by the user device, an initial message to at least one satellite when the user device is within range of the at least one satellite, wherein the determination as to whether reception of the message is urgent is based on a context of the initial message or based on a recipient of the initial message, and wherein the message is a response to the initial message.

4. The computer-implemented method of claim 3, wherein the at least one satellite corresponds to a different satellite than the particular satellite.

5. The computer-implemented method of claim 3, wherein the at least one satellite corresponds to the particular satellite.

6. The computer-implemented method of claim 3, further comprising:
determining, by the user device, that the user device is not within range of the at least one satellite after sending the initial message to the at least one satellite; and
transitioning to an idle state in response to determining that the user device is not within range of the at least one satellite, wherein the user device determines that the user device is within range of the particular satellite when the user device is in the idle state.

7. The computer-implemented method of claim 1, wherein determining that the user device is within range of the particular satellite comprises scanning, by the user device, a plurality of frequency bands to detect a presence of the particular satellite, and further comprising transitioning from an idle state to a connected state in response to detecting the presence of the particular satellite, wherein the particular satellite provides access to a public land mobile network.

8. The computer-implemented method of claim 7, wherein the idle state corresponds to a Radio Resource Control (RRC) idle state, and wherein the connected state corresponds to a RRC connected state.

9. A user device comprising:
a memory; and
a processor coupled to the memory, the processor configured to:
determine that the user device is within range of a particular satellite;
send a connection request to the particular satellite in response to determining that the user device is within range of the particular satellite, wherein the connection request is forwarded to a network device, via the particular satellite, to indicate to the network device that the user device is available to receive messages via the particular satellite; and
receive, via the particular satellite, a message from the network device in response to sending the connection request.

10. The user device of claim 9, wherein the processor is further configured to:
determine whether reception of the message is urgent prior to determining that user device is within range of the particular satellite,
wherein the connection request is sent to the particular satellite based on a determination that reception of the message is urgent.

11. The user device of claim 10, wherein the processor is further configured to:
send an initial message to at least one satellite when the user device is within range of the at least one satellite, wherein the determination as to whether reception of the message is urgent is based on a context of the initial message or based on a recipient of the initial message, and wherein the message is a response to the initial message.

12. The user device of claim 11, wherein the at least one satellite corresponds to a different satellite than the particular satellite.

13. The user device of claim 11, wherein the at least one satellite corresponds to the particular satellite.

14. The user device of claim 11, wherein the processor is further configured to:
determine that the user device is not within range of the at least one satellite after sending the initial message to the at least one satellite; and
transition to an idle state in response to determining that the user device is not within range of the at least one satellite, wherein the user device determines that the user device is within range of the particular satellite when the user device is in the idle state.

15. A non-transitory computer-readable medium comprising instructions that, when executed by a processor within a user device, causes the processor to perform operations comprising:
determining that the user device is within range of a particular satellite;
sending a connection request to the particular satellite in response to determining that the user device is within range of the particular satellite, wherein the connection request is forwarded to a network device, via the particular satellite, to indicate to the network device that the user device is available to receive messages via the particular satellite; and
receiving, via the particular satellite, a message from the network device in response to sending the connection request.

16. The non-transitory computer-readable medium of claim 15, wherein the operations further comprise:
determining whether reception of the message is urgent prior to determining that user device is within range of the particular satellite,
wherein the connection request is sent to the particular satellite based on a determination that reception of the message is urgent.

17. The non-transitory computer-readable medium of claim 16, wherein the operations further comprise:
sending an initial message to at least one satellite when the user device is within range of the at least one satellite, wherein the determination as to whether reception of the message is urgent is based on a context of the initial message or based on a recipient of the initial message, and wherein the message is a response to the initial message.

18. The non-transitory computer-readable medium of claim 17, wherein the at least one satellite corresponds to a different satellite than the particular satellite.

19. The non-transitory computer-readable medium of claim 17, wherein the at least one satellite corresponds to the particular satellite.

20. The non-transitory computer-readable medium of claim 17, wherein the operations further comprise:
determining that the user device is not within range of the at least one satellite after sending the initial message to the at least one satellite; and
transitioning to an idle state in response to determining that the user device is not within range of the at least one satellite, wherein the user device determines that the user device is within range of the particular satellite when the user device is in the idle state.
